(19) United States
(12) Patent Application Publication
(10) Pub. No.: US 2014/0151996 A1
(43) Pub. Date: Jun. 5, 2014

(54) ELEMENT FOR SECURITY DOCUMENT COMPRISING AN OPTICAL STRUCTURE

(71) Applicant: ARJOWIGGINS SECURITY, Boulogne Billancourt (FR)

(72) Inventor: Michel Camus, Rives (FR)

(21) Appl. No.: 13/924,858

(22) Filed: Jun. 24, 2013

Related U.S. Application Data
(63) Continuation of application No. PCT/IB2011/055695, filed on Dec. 15, 2011.

(30) Foreign Application Priority Data
Dec. 22, 2010 (FR) 1005050

(51) Int. Cl. B42D 15/00

(52) U.S. Cl. CPC B42D 15/00
USPC 283/67; 283/85

(57) ABSTRACT

A security element adapted for integration into a security document. The security element having a substrate with a first face and a second face. An optical structure is disposed on the first face, and at least two patterns are inscribed on the second face. The two patterns are at least partially identical. The first pattern is observable at a first position on the second face through the optical structure along a first viewing angle. The second pattern is observable at a second position on the second face through the optical structure along a second viewing angle. Authenticity of the document may be verified by comparing the observed patterns.

### CROSS REFERENCE TO RELATED APPLICATIONS

This application is a continuation of PCT Patent Application No. PCT/IB2011/055695, titled “ELEMENT FOR SECURITY DOCUMENT COMPRISING AN OPTICAL STRUCTURE,” filed Dec. 15, 2011, which claims priority to French Patent Application No. 10/05050 with the same title and a filing date of Dec. 22, 2010, which is herein incorporated by reference.

### BACKGROUND OF THE INVENTION

1. Field of the Invention

The present invention relates to security elements. Specifically, the invention relates to a security element with an optical structure making it possible to vary the appearance of the security element when the viewing angle is modified.

2. Brief Description of the Related Art

It is desirable to equip security document with security elements that can be used to verify the authenticity of the document. The expression “security document” denotes a valuable document, for example a means of payment, such as a bank note, a check or a restaurant voucher, a lottery ticket, a transport pass or an entry ticket to a cultural or sporting event and/or a document for identifying people, such as an identity card, a visa, a passport or a driving license.

The financial value that they represent or the value to which they give access make these documents particularly sensitive in terms of security. Similarly, the authentication of people and the access to certain rights given by these security documents easily show that it is essential to guard against attempts at falsification or forgery in the field of security documents. There is therefore a certain need for elements that allow, simply and in a manner accessible to all, the authentication and/or the identification of the security document bearing the element.

It is known in the art to produce security elements with optical structures such as lenticular arrays which are combined with specific printings in order to produce effects of movements, of depth and of relief so as to guard against attempts at falsification or forgery of a security document. One of the main advantages of these security elements with optical structures lies in their inability to be reproduced by copying using a photocopier or by simple printing.

Generally, such security elements equipped with optical structures are integrated into a security document so that a portion is exposed to the air and is therefore visible to the observer. The difference in refractive index between the material of the optical structure and the air produces a refraction of the light rays which is behind the effects of movement during observation, in particular by magnifying moiré effects.

The known magnifying moiré principle creates an effect of depth or an impression of movement during a change in the viewing angle that is due to the relative position between two different images or patterns printed on the security element with respect to the lenticular array. For example, a magnifying moiré effect is obtained by means of an array of images or patterns in which the images or patterns have the same distribution as the lenses of the lenticular array but with an angular offset. The expression “same distribution” is understood to mean the fact that the spacing pitch between the images is constant and identical to that between the lenses. It is also possible to obtain a magnifying moiré effect when the spacing pitch between the images varies uniformly and slightly with respect to that between the lenses, which is constant.

The security elements with optical structures that create an effect of depth or an impression of movement are visually attractive and relatively difficult to copy identically. Moreover, these effects are generally associated with variations in the dimensions of the pattern and amplitudes of movement which are a function of the degree of magnification. However, the complexity of the optical effects generated sometimes makes them difficult to authenticate and above all to distinguish, in particular in the case of forgery. For example, a forged security element having a similar but slightly different complex optical effect will be difficult to recognize with respect to an original security element since the effect is itself complex.

### SUMMARY OF THE INVENTION

The long-standing but heretofore unfulfilled need for a reliable optical security element is now met by a new, useful, and nonobvious invention. The novel security element comprises an optical structure which exhibits novel optical effects for a simple and immediate authentication and/or identification.

For this purpose, one subject of the invention is a security element comprising a substrate provided with a first face equipped with an optical structure and with a second face, characterized in that it comprises at least a first pattern and a second pattern inscribed on the second face of the substrate, the first pattern being observable through the optical structure along a first viewing angle at a first position on the second face, the second pattern being observable through the optical structure along a second viewing angle, different from the first angle, at a second position on the second face different from the first position, the first pattern and the second pattern being at least partially identical.

Advantageously according to the invention, the observer, varying the angle of inclination of the security element according to the invention, observes that a same pattern appears and disappears from a first position in order to appear and disappear, alternately, at a second position on the security element. This appearance of a single pattern at different positions on the security element constitutes an easily recognizable optical effect and therefore allows a simple, immediate and unequivocal authentication and/or identification of the security element according to the invention.

The expression a “same pattern” is understood to mean a single pattern or image which may have several occurrences, the appearance, that is to say the shape, aspect and/or color, of which is substantially the same or at least partially identical. For example, the pattern is in the form of an alphanumerical symbol or is representative of a symbol, a logo, a character, a landscape, an object, etc.

For reasons of conciseness and clarity, the first pattern and/or second pattern, which are at least partially identical, may be denoted in what follows by “the pattern”.

Preferably, the substrate is at least partially transparent or translucent. The substrate may for example be or comprise a film of a transparent or translucent thermoplastic material, for example polyester or PET. Similarly, the optical structure is at least partially transparent or translucent so that the pattern inscribed on the second face of the substrate is observable through the optical structure and the substrate.

According to one particular embodiment of the invention, a reflective or at least partially opaque or semi-reflective surface is observable at the first position along the second viewing angle and at the second position along the first viewing angle.

Advantageously, the appearance of the single pattern at a particular position on the security element, then its disappearance, when it is replaced by a reflective or semi-reflective surface at this particular position, reinforces the contrast effect between the appearance and the disappearance which facilitates even more the recognition and authentication of the security element.

According to one particular embodiment of the invention, the optical structure is composed of a lenticular array comprising a set of lenses. For example, the lenses of the lenticular array are cylindrical or hemispherical concave, convex or Fresnel and are positioned in a hexagonal, compact hexagonal or rectangular arrangement. The expression “compact hexagonal” is understood to mean an arrangement in which the lenses are included in a hexagonal shape with no space between them. Preferably, the lenticular array consists of coplanar hemispherical lenses positioned in staggered rows, of hexagonal lenses arranged in a “honeycomb” or of juxtaposed cylindrical lenses.

The optical structure may be produced by embossing, in particular by heat embossing or by embossing followed by ultraviolet crosslinking, or by molding. The optical structure may also comprise a printed lenticular array comprising juxtaposed or non-juxtaposed lenses, for example by UV printing, for example by screen printing, photogravure, typography, or else by inkjet printing.

Such arrangements of the lenses according to the invention offer optimal compaction in order to bring out a greater density of printing points or of pattern elements which are printed opposite the lenses. The overall resolution of the pattern is therefore increased. The security element can be even more easily authenticated thereby.

According to yet another particular embodiment of the invention, the first pattern and the second pattern, which are at least partially identical, consist of a set of unconnected pattern elements, each pattern element being positioned opposite a corresponding lens, and in that, at said first position, each pattern element is positioned on a first side with respect to the center or the axis of said corresponding lens, and each pattern element at said second position is positioned on a second side, opposite the first side, with respect to the center or to the axis of said corresponding lens.

Thus, at the first position, each pattern element is positioned in the same manner with respect to the corresponding lens. In particular, the pattern elements forming the first pattern are distributed in the same manner as the corresponding lenses, that is to say with the same spacing pitch and without angular offset so as to avoid any moiré effect.

Furthermore, a single pattern element is positioned opposite a corresponding lens. Each lens is therefore associated with a sole pattern element in order to make the pattern appear and disappear. In particular, according to the invention, positioning several patterns or pattern elements opposite a single lens is avoided. Positioning several partial images that form an intertwined image opposite a single lens in order to generate complex optical effects that are difficult to distinguish is also avoided.

The pattern elements may be obtained by perforation, deposition and/or voids of material. For example, the pattern elements are obtained by a metallization or demetallization of materials selected from: metals, metallic compounds, alloys, metallic lacquers or inks, such as that described in document EP 279 880. Alternatively, the pattern elements may be obtained by selective, positive or negative printing of an ink containing pigments chosen from: carbon black pigments, magnetic pigments, colored pigments, pigments that are visible under UV or IR radiation or a mixture of the latter. The pattern elements of the screened pattern may have variable shapes and/or dimensions so as to form a multitone pattern.

The security element may comprise unconnected magnetic elements that form a magnetic code.

Advantageously, the pattern elements of the screened pattern may be obtained by selective printing of an ink containing magnetic particles or by application of a vacuum metallization. This screened pattern thus forms a magnetic code having a particular magnetic response, linked to the pattern, which makes it possible to authenticate the security document bearing the security element.

For example, a banknote of a particular denomination comprising the security element, with a particular screened pattern which is linked to the denomination, has a magnetic response associated with the denomination and which makes it possible to authenticate the banknote. Reading the magnetic code also makes it possible to identify the denomination automatically during treatment in a sorting machine.

The magnetism is read or detected for example using inductive heads which measure variations in the magnetic flux. The magnetic particles may be applied as layers of variable particle concentration so as to vary the flux in order to obtain a more precise code or to increase the amount of codes which can be affected.

Advantageously, the magnetic code is optically masked since it merges with the screened pattern. The presence of the code cannot therefore be detected visually but only using a suitable reading device.

Alternatively, the printing of the magnetic ink may be applied under the pattern elements so as to be masked by the latter.

According to one particular embodiment, the zone of the magnetic code comprises at least two magnetic materials having high (for example greater than or equal to 1000 Oe (80 kA/m), better still 2000 Oe (160 kA/m), or even 4000 Oe (320 kA/m)) and different coercivities but that are arranged in or on the security element so as to have substantially equal (and high) remanences, as disclosed in US 2009/0008922 A1, for example by acting on the thickness and/or the concentration. The high coercivity makes it possible in particular to prevent fraudulent attempts to modify the magnetic code.

Alternatively, the security element may comprise a weakly coercive magnetic zone (for example between 10 and 500 Oe (800 A/m to 40 kA/m)) covered at least partially with a highly coercive magnetic zone (preferably greater than 1000 Oe (80 kA/m)) which magnetizes the weakly coercive magnetic zone to prevent fraudulent attempts to modify the magnetic code, as disclosed in EP 1 618 006 B1. The weakly coercive magnetic zone comprises a plurality of partial zones that can be magnetized independently and that form the bits, or unconnected magnetic elements, of the magnetic code.

According to another particular embodiment of the invention, the distance between the optical structure and the first pattern or second pattern inscribed is preferably less than or equal to the focal distance of the lenses of the lenticular array. Furthermore, according to the invention, the distance between the optical structure and the pattern inscribed is preferably greater than the radius of curvature at the center of the lenses of the lenticular array. The distance between the optical structure and the pattern inscribed is understood to mean the distance between the top of the lenses of the lenticular array and the second face of the substrate along a direction perpendicular to the surface of the support.

In the exemplary case of a truncated hemispherical lens also referred to as a “flat-convex lens”, that is to say resulting from the combination of a flat dioptre and of a spherical dioptre, the radius of curvature at the center of a lens, the height and the radius of the lens are linked by the following known formula: H(2Rc−H)=r².

The solution to this equation is the following: H=Rc−√(Rc²−r²), in which “Rc” is the radius of curvature at the center of the lens, “H” is the height of the lens and “r” is the radius of the lens at the flat dioptre.

It is understood that, according to this formula resulting from conventional geometry, there is a given relationship between the height, the radius of curvature at the center of the lens and the diameter of the lens. The height of a lens can therefore be determined from the radius of curvature and diameter of the lens. It is therefore advantageously possible to define a compromise between the thickness of the security element and the resolution of the pattern.

A satisfactory compromise between thickness and resolution is preferably obtained for a lenticular array in which the lenses have a diameter between 15 and 50 microns for a radius of curvature between 10 and 40 microns.

For example, for a lenticular array in which the lenses have a diameter of 20 microns for a radius of curvature of 15 microns, the patterns are preferably inscribed at a distance between 20 and 30 microns.

For example, for a lenticular array in which the lenses have a diameter of 50 microns for a radius of curvature of 30 microns, the patterns are preferably inscribed at a distance between 25 and 45 microns.

Preferably, each pattern element is inscribed on the face of the security element opposite a corresponding lens so as to have a width at most equivalent to the radius of the corresponding lens. This arrangement makes it possible to make the pattern appear and disappear in a suitable manner, that is to say that the appearance time is substantially equivalent to the disappearance time when the observer varies the viewing angle of the security element uniformly over time. This allows an effective authentication and/or identification of the security element which reveals/hides the pattern in a sufficient manner to be easily noted by the observer.

With the arrangement defined above, the security element according to the invention has a reduced thickness while retaining an appearance and disappearance effect that is particularly effective for integration into security documents, even for relatively thin documents such as banknotes. Since banknotes generally have a thickness of around 100 microns, the security elements that they bear consequently should not exceed approximately this thickness.

For example, a security element according to the invention may have a lenticular array comprising a set of identical truncated hemispherical lenses having a diameter of around 50 microns, for a radius of curvature of 30 microns and a height of around 14 microns. In this case, as explained above, the distance between the height of the lenses of the lenticular array and the pattern inscribed may be between 25 and 45 microns, for example equivalent to the radius of curvature at the center of the lenses of the lenticular array. Consequently, the thickness of the security element thus obtained is around 30 microns which is particularly suitable for integration into a thin security document such as a banknote. Furthermore, the 30 micron diameter of the lenses results in a resolution of the pattern that is completely satisfactory for authentication and identification. Finally, the inscription of a pattern element covering a surface corresponding to around half of the surface of a lens means a pattern element width of around 15 microns which makes it possible to dispense with complex and expensive inscription processes such as those carried out using a laser for very high resolutions, for example for printing a complete pattern behind each lens as in the case of a magnifying moiré effect.

The pattern may be formed on the security element by metallization and/or demetallization, for example with aluminum. Metallization/demetallization processes have a fineness and a definition such that they are difficult to reproduce by printing which therefore makes it possible to prevent forgery by printing. However, the pattern may be inscribed by a printing process of the offset, copperplate, laser, inkjet, microlithography or photogravure type or by screen printing. It is understood that the pattern may be inscribed as a positive or negative pattern. The pattern may also be constituted by points having optical light diffraction properties which are positioned on a reflective surface of mirror type so as to exhibit a high contrast with respect to the surface. The points constituting the pattern may be achromatic, that is to say that they do not break down white light, and may be positioned on a non-achromatic surface.

Alternatively, the pattern may be printed with colored or colorless inks, which may or may not be visible to the naked eye, for example inks that are visible only under ultraviolet or infrared light, opaque inks, fluorescent inks, phosphorescent inks, thermochromic inks, photochromic inks, translucent and/or transparent inks, etc. In the case of visible printing, the light source used to illuminate the optical structure is for example ambient light originating from the sun or artificial light. In the case of an ink revealed under excitation by a given wavelength, the appropriate lighting device will be used.

According to another embodiment, the invention may have the following distinctive features:
the reflective or at least partially opaque or semi-reflective surface is metallic,
said first and/or second patterns are printed on the reflective or at least partially opaque or semi-reflective surface.

According to another particular embodiment, the security element according to the invention comprises an adhesive, in particular a heat- sealable lacquer, the adhesive being borne by each face of the security element. Alternatively, the adhesive may be borne by a single face.

According to another particular embodiment of the invention, the face of the substrate equipped with the optical structure comprises an adhesive over zones of this face which are not covered by the optical structure, the optical structure being devoid of adhesive on its surface. Advantageously, the presence of the adhesive only in zones of the substrate not covered by the optical structure may make it possible not to adversely affect the optical properties of the structure. Furthermore, the security element may be of elongated shape and have edges covered with an adhesive, in particular a heat-sealable resin or lacquer. In the case of a security element of elongated shape, for example in the form of a security thread, the optical structure may extend only partially over the width of the security thread so that the substrate of the security thread has at least one edge zone not covered by the optical structure and on which an adhesive may be provided. This edge zone may also be covered with a pattern, for example the same pattern as described previously. The edge zone may be discontinuous or continuous and extend from one edge to the other along the security element in order to provide adhesion along the security element. Consequently, the adhesive and the edge zone make it possible to strengthen the cohesion between the security element and an article, for example a security document, in which it is incorporated.

For example, the distance between two edge zones of the security element is between 2 and 9 mm and the width of the edge zone may be between 0.5 and 2 mm. The security element has a width approximately between 2 and 10 mm.

The adhesive may be transparent, translucent or opaque. The adhesive may be heat-sealable. The adhesive may be colorless or colored, visible to the naked eye, under ultraviolet (UV) and/or infrared (IR) light, fluorescent, phosphorescent, thermochromic, photochromic, inter alia. The adhesive may, for example, be a heat-sealing sealant, for example a heat-sealing lacquer, an ultraviolet (UV)-crosslinkable agent, an adhesive to be irradiated, a pressure sensitive adhesive (PSA), a lacquer with a solvent base, of polyester type for example, an adhesive in the aqueous phase, etc. The adhesive may advantageously be an adhesive based on a polyvinyl acetate. The incorporation of the adhesive into the security element may be carried out by coating or by printing.

The zones which are not covered by the optical structure may also include a magnetic code. For example, the magnetic code consists of unconnected elements comprising magnetic particles. The elements may be applied by selective printing of an ink containing magnetic particles.

The magnetic code thus formed has a particular magnetic response which makes it possible to authenticate the security document bearing the security element. Advantageously, this magnetic code may be optically masked by an opaque layer. According to one particular embodiment, the adhesive may constitute the opaque layer. Consequently, the presence of the code cannot be detected visually but only using a suitable reading device.

The magnetic particles may also be mixed with the adhesive. During the encoding process, these particles are magnetized in the direction of the north pole or south pole. The polarity of the magnetic particles is changed in order to define bits forming a magnetic code.

The invention extends to a security support consisting of natural fibrous materials, for example of cellulose and/or cotton, and/or of synthetic fibers, which comprises at least one security element as described previously. In particular, the security element is in the form of a thread which is at least partially integrated into the security support. For example, the security element is incorporated as windows in a security document so that the same pattern can be observed at the first position and at the second position at least through the window.

Alternatively, the security element is in the form of a strip or a patch applied to a surface of the support.

The invention extends to a security document such as a passport, an identity card, a driving license, an interactive trading or playing card, a means of payment, in particular a payment card, a banknote, a gift token or a voucher, a travel pass, a loyalty card, a benefit card or a season ticket, including the security element or the security support described previously.

The invention also extends to a method of authenticating or identifying a security document, wherein information regarding the identity or the authenticity of the security document is determined by observing the first and second patterns, which are at least partially identical, the first pattern being observable through the optical structure along a first viewing angle at a first position on the second face, and the second pattern being observable through the optical structure along a second viewing angle, different from the first angle, at a second position on the second face different from the first position.

### DESCRIPTION OF THE DRAWINGS

For a fuller understanding of the invention, reference should be made to the following detailed description, taken in connection with the accompanying drawings, in which:

FIG. 1a is a cross-sectional view of a schematic illustration of a security element according to the present invention depicting a first viewing angle.

FIG. 1b is a cross-sectional view of a schematic illustration of a security element according to the present invention depicting a second viewing angle.

FIG. 2a is a front view of a schematic illustration of the details of a security element according to the invention.

FIG. 2b is a front view of a schematic illustration of the details of a security element according to the invention.

FIG. 3a is a front view of a schematic illustration of the security element according to the invention as seen from the first viewing angle.

FIG. 3b is a front view of a schematic illustration of the security element according to the invention as seen from the second viewing angle.

FIG. 4 is a schematic illustration of a security document with an integrated security element according to the invention.

### DETAILED DESCRIPTION OF THE INVENTION

In the following detailed description of the preferred embodiment, reference is made to the accompanying drawings, which form a part hereof, and within which specific embodiments are shown by way of illustration by which the invention may be practiced. It is to be understood that other embodiments may be utilized and structural changes may be made without departing from the scope of the invention.

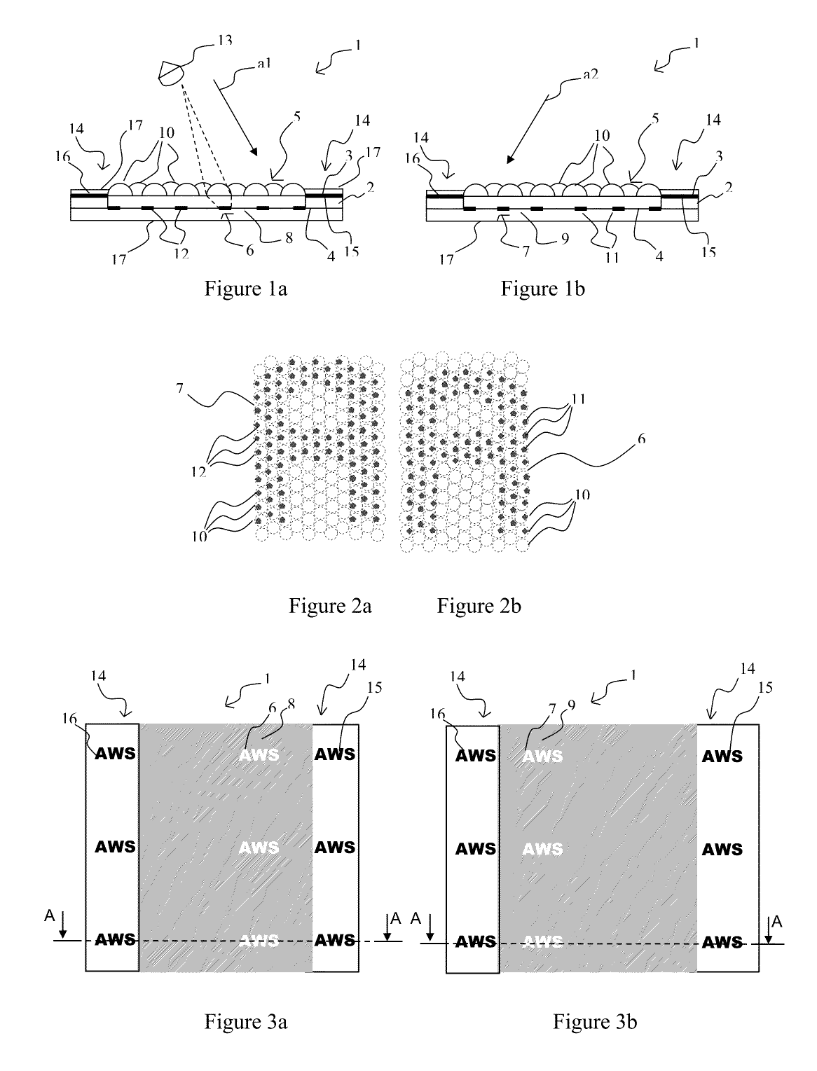

Shown in FIGS. 1a and 1b is a security element 1 according to the invention comprising a substrate 2 provided with a first face 3 and and with a second face 4.

The first face 3 of the substrate 2 is equipped with an optical structure 5. While on the second face 4 at least a first pattern 6 and a second pattern 7 are inscribed respectively at a first position 8 and at a second position 9 on this second face 4.

The optical structure 5 is composed of a lenticular array comprising a set of lenses 10 which are for example cylindrical or hemispherical, concave, convex or Fresnel and are positioned in a hexagonal, compact hexagonal or rectangular arrangement.

In the detail of FIGS. 2a and 2b, it is shown that the lenticular array 5 consists of a set of hemispherical lenses 10 which are positioned coplanar on the first face 3 and arranged in offset lines or columns. For example, the lenticular array is formed of several lenses 10 positioned adjacent to one another in order to form a column of contiguous lenses. This column of lenses is itself adjacent to another column of lenses 10, the columns of lenses 10 themselves being arranged in an offset manner with respect to one another, for example with an offset of around a hemispherical lens radius in a direction along the column of lenses 10. This arrangement of the lenses in staggered rows allows optimal compaction of the lenses 10 on the first face 3 of the substrate 2, which has the effect of increasing the overall resolution of the pattern for a more effective authentication of the security element.

Alternatively, the lenses 10 may be of hexagonal shape and arranged in a distribution corresponding to a “honeycomb”. The lenses 10 may also be of cylindrical shape and positioned in a juxtaposed manner with respect to one another.

The lenticular array of the optical structure 5 illustrated in FIGS. 1a and 1b shows a transverse cross section of the security element along an axis A (illustrated in FIGS. 3a and 3b) corresponding to a line of lenses 10 from FIGS. 2a and 2b, which passes through the center of the hemispherical lenses of said line of lenses 10. For reasons of clarity, the first pattern 6 and the second pattern 7 inscribed on the second face of the substrate 2 as illustrated in FIGS. 1a and 1b do not correspond exactly to the first pattern 6 and second pattern 7 illustrated in FIGS. 2a and 2b. FIGS. 1a and 1b schematically illustrate the first pattern 6 and the second pattern 7 which are inscribed respectively at a first position 8 and a second position 9 on the second face 4, respectively on the right and left of the security element 1 in the exemplary embodiment from FIGS. 1 to 3.

Furthermore, FIGS. 1a, 1b, 2a and 2b are intended to show that, according to the invention, the first pattern 6 and the second pattern 7 consist of a set of unconnected pattern elements, respectively referred to below as the first pattern elements 11 and second pattern elements 12. Each pattern thus has a “pixelated” appearance.

Advantageously, the pattern elements 11 and 12 together forming respectively the first pattern 6 and second pattern 7 are inscribed on the second face 2 in the style of a “screened pattern”.

It is necessary to give the expression “screened pattern” a broad meaning which covers all types of screens or pseudo-screens, the shape of the pattern elements 11 and 12 not being limited to a particular shape, but being able to be any shape.

A simple screened pattern corresponds to a halftone pattern or a binary pattern, that is to say that the shades of the pattern are two in number, for example black and white, or in the case of a selective metallization of the second face 4 of the substrate 2, the two shades of the image are, in a first zone, the metallization and, in a second zone, the absence of metallization.

Furthermore, a more complex screened pattern, that is to say multi-tone pattern, may for example be obtained by a frequency-modulation or amplitude-modulation screening process. According to these respective processes, the size of the screen points varies as a function of the optical density to be reproduced or the size of the screen points is constant but the spacing varies as a function of the optical density to be reproduced. A pattern having a three-dimensional printing effect can thus be produced.

Shown in an enlarged manner in FIG. 2a is the letter “A” corresponding to a portion of the second pattern 7 “AWS” inscribed on the second face 4 and illustrated on the left in FIG. 3b. The letter “A” of the second pattern 7 “AWS” consists of a second set of unconnected pattern elements 12 which are each positioned opposite a corresponding lens 10. In the example from FIG. 2a, it is shown that the second pattern elements 12 are formed by points of circular shape having for example a diameter of around 15 microns and positioned on one side with respect to the center of the corresponding lens, on the left in the exemplary embodiment of FIG. 2a.

In the same manner, shown in an enlarged manner in FIG. 2b is the letter “A” corresponding to the first pattern 6 “AWS” inscribed on the second face 4 and illustrated on the right in FIG. 3a.

The letter “A” of the first pattern 7 “AWS” consists of a first set of unconnected pattern elements 11 which are each positioned opposite a corresponding lens 10. In the example from FIG. 2b, it is shown that the first pattern elements 11 are formed by points of circular shape having for example a diameter of around 15 microns and positioned on the opposite side with respect to the center of the corresponding lens, on the right in the exemplary embodiment of FIG. 2b.

According to the invention, each pattern element 11 and 12 is positioned opposite a corresponding lens 10. Moreover, at said first position 8 each first pattern element 11 is positioned on a first side with respect to the center of the corresponding lens, that is to say with respect to the center of the lens opposite which it is positioned. At said second position 9 each second pattern element 12 is positioned on a second side with respect to the center of the corresponding lens, that is to say with respect to the center of the lens opposite which it is positioned. The first side is opposite the second side with respect to the center of the lenses.

Even though the first pattern elements 11 and second pattern elements 12 are each positioned opposite different lenses, it is understood that, on the axis A passing through the centers of the lenses forming a line, if each first pattern element 11 is positioned on a first side with respect to the center of the corresponding lens, for example on the right in the exemplary embodiment of the figures, the second pattern element 12 is then positioned on a second side with respect to the center of the corresponding lens, which is diametrically opposite the first side, on the left in the exemplary embodiment.

Consequently, in the case of an array of hemispherical lenses, the first and second sides are diametrically opposite. In the case of cylindrical lenses, the first and second sides are axially opposite, that is to say positioned on opposite sides with respect to the axis of the lens.

Preferably, each pattern element 11 or 12 is inscribed on the second face 4 opposite a corresponding lens so as to cover a surface, the width of which along the axis A is approximately equivalent to the radius of the corresponding lens 10, for example 15 microns.

Furthermore, according to the invention, the distance between the lenticular array 5 and the first pattern 6 or the second pattern 7 is less than or equal to the focal distance of the lenses 10 of the lenticular array. Moreover, according to the invention, the distance between the lenticular array 5 and the inscribed pattern 6 or 7 is preferably greater than or equal to the radius of curvature at the center of the lenses 10 of the lenticular array 5. The distance between the lenticular array and the inscribed pattern being understood as the distance between the top of the lenses of the lenticular array and the inscribed pattern or between the top of the lenses of the lenticular array and the second face 4 of the substrate 2.

Advantageously, the surface covered by the pattern elements 11 or 12 with respect to the corresponding lens and the distance between these pattern elements and the lenticular array 5 makes it possible to simply obtain a thin security element which may be integrated into a security document such as a banknote. Moreover, with this arrangement, the pattern elements 11 and 12 observed through the lenses 10 of the optical structure 5 are enlarged and each cover the entire visible surface of the corresponding lens so that the first pattern 6 and second pattern 7 appear substantially unscreened.

This arrangement enables the first pattern 6 and the second pattern 7 to appear and disappear alternately in a manner particularly suitable for the authentication and/or identification of the security element 1.

Indeed, with a security element according to the invention as described previously, when the observer 13 varies his viewing angle along the axis A, for example from the left along an angle a1 to the right along an angle a2 in the direction of FIGS. 3a and 3b, he firstly observes the first pattern at the first position as illustrated in FIG. 3a then he observes the second pattern at the second position as illustrated in FIG. 3b. Since the first pattern and the second pattern are substantially identical, the appearance and disappearance of a same pattern at different positions constitutes an easily recognizable optical effect for simple and immediate authentication and/or identification.

Moreover, provision may be made for the pattern elements to be obtained by a metallization or demetallization, which reinforces the contrast effect between the appearance and disappearance and facilitates even more the recognition and authentication of the security element.

Provision may also be made for the pattern elements to be printed on the second face 4 of the substrate 2 then covered with a reflective or semireflective layer. Moreover, different printing may be produced on the semireflective layer so as to make another pattern appear which would only be visible in transmitted light for example.

To further facilitate the authentication and/or identification, the security element 1 may comprise other identical patterns arranged in the same way as before but at different positions, as illustrated in FIGS. 3a and 3b.

In one particular embodiment of the invention, the first face 3 of the substrate 2 is not completely covered by the optical structure 5. In particular, the edge zones or lateral zones 14 of the first face 3 are free of lenses 10 and may receive a third reference pattern 15 and fourth reference pattern 16 which are at least partially identical to the first pattern 6 and to the second pattern 7.

For example, the third pattern 15 is positioned in a lateral zone 14 in the vicinity of the first pattern 6 so as to form a comparison pattern with the latter. Since the third pattern 15 is located outside of the optical structure its appearance is fixed, that is to say that it does not vary as a function of the viewing angle, thus facilitating the recognition and identification of the first pattern 6 which appears and disappears. Similarly, the fourth pattern 16 is advantageously positioned in a lateral zone 14 in the vicinity of the second pattern 7 in order to serve as a comparison element.

The third pattern 15 and fourth pattern 16 may be obtained by selective, positive or negative printings, perforations, depositions and/or voids of materials.

Provision may also be made for the security element according to the invention to comprise an adhesive 17, in particular a heat-sealable lacquer or resin. The adhesive 17 may be borne by the lateral zones 14 and/or by the second face 4 of the substrate 2. Advantageously, an adhesive 17 borne by the two faces 3 and 4 of the support 2 optimally strengthens the cohesion between the security element 1 and the security document in which it is incorporated. Preferably, the lateral zone 14 and the adhesive 17 extend along the security element 1 so as to ensure the complete cohesion of the security element in the document.

The security element may be incorporated at least partially in bulk into the security document, and one portion only appears visible, for example through a plurality of windows formed in the fibrous mass being formed as described in document EP 59056.

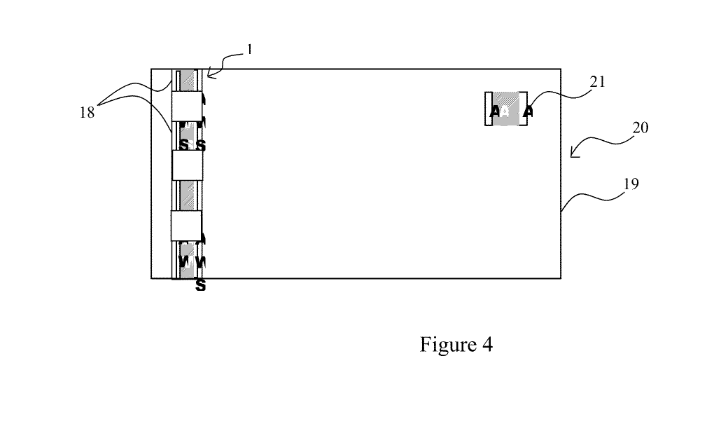

As illustrated in FIG. 4, when the security element is incorporated as windows 18 in a cellulose support 19, for example to form a security document 20, the windows may advantageously allow the simultaneous observation of at least the first pattern 6 and second pattern 7 and of at least one portion of the third reference pattern 15 and fourth reference pattern 16.

Alternatively, the security element is deposited on the surface of the security document by forming an overthickness or in an elongated cavity provided for housing the element without generating an overthickness.

Finally, the security element may be in the form of a patch 21 which is deposited on the surface of the security document.

Preferably, the security document incorporating the security element consists of natural fibrous materials, for example of cellulose and/or cotton, and/or of synthetic fibers. The security support may also be produced from plastics such as, for example, a Polyart™ film sold by the company ARJOBEX Ltd.

The security document including the support and the security element may be a document such as a passport, an identity card, a driving license, an interactive trading or playing card, a means of payment, in particular a payment card, a gift token or a voucher, a travel pass, a loyalty card, a benefit card or a season ticket.

A security document thus obtained therefore comprises at least one security element as described above which constitutes a “first level” security element. It may however comprise other “first level” security elements and/or at least one “second level” and/or “third level” security element.

The document may in particular comprise the following security elements, alone or in combination:
luminescent dyes and/or pigments and/or interference pigments and/or liquid crystal pigments, in particular in the printed form or mixed with at least one constituent layer of the document,
components, dyes and/or pigments which are photochromic or thermochromic, in particular in the printed form or mixed with at least one constituent layer of the document,
an ultraviolet (UV) absorber, in particular in the coated form or mixed with at least one constituent layer of the document,
a specific light-collecting material, for example of the “waveguide” type, for example a material which collects luminescent light, such as polycarbonate-based polymer films sold by Bayer under the LISA® name,
a multilayer interference film,
a structure having variable optical effects based on interference pigments or liquid crystal pigments,
a birefringent or polarizing layer,
a diffraction structure,
an embossed image,
means producing a “moiré effect”, it being possible for such an effect, for example, to reveal a pattern produced by the superimposition of two security elements on the document, for example by bringing together lines of two security elements,
a partially reflective refractive element,
a colored filter,
another goniochromatic or holographic metalized foil,
a layer having a variable optical effect based on interference pigments or liquid crystal pigments,
a flat security element having a relatively small size, such as a small board, which is visible or invisible, in particular luminescent, with or without an electronic device,
particles or agglomerates of particles of pigments or dyes of HI-LITE type, which are visible or invisible, in particular luminescent,
security fibers, which are in particular metallic, magnetic (having soft and/or hard magnetism), or absorbent, or excitable towards ultraviolet radiation, visible light or infrared radiation, and in particular near infrared (NIR) radiation,
an automatically readable security having specific and measurable characteristics of luminescence (for example fluorescence or phosphorescence), of absorption of light (for example ultraviolet, visible or infrared light), of Raman activity, of magnetism, of microwave interaction, of interaction with X-rays or of electrical conductivity.

One or more security elements as defined above may be present in the document and/or in one or more constituent layers of the document or in one or more security elements incorporated into the document and/or in one or more constituent layers of the document, such as, for example, a thread, a fiber or a small board.

One at least of the constituent layers of the document may also comprise a first level security element, such as a watermark or a pseudo-watermark, which is at least partially superimposed with a translucent region of the document.

It is understood that the expression “having a” or “comprising a” is synonymous with “having at least one” or “comprising at least one”, unless otherwise specified.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

What is claimed is:

1. A security element comprising:
a substrate having a first face and a second face, the first face equipped with an optical structure, the second face having at least a first pattern and a second pattern inscribed thereon, the first and the second patterns being at least partially identical;
wherein the first pattern is observable at a first position on the second face through the optical structure along a first viewing angle; and
wherein the second pattern is observable at a second position on the second face through the optical structure along a second viewing angle.

2. The security element as claimed in claim 1, further comprising the second face having a reflective, a semi-reflective, or an at least partially opaque surface, the surface being observable at the first position along the second viewing angle and at the second position along the first viewing angle.

3. The security element as claimed in claim 1, further comprising the optical structure having a lenticular array comprising a set of lenses.

4. The security element as claimed in claim 3, wherein the distance between the optical structure and the first pattern and the second pattern is less than or equal to a focal distance of the lenses of the lenticular array.

5. The security element as claimed in claim 3, wherein the distance between the optical structure and the first pattern and the second pattern is greater than or equal to a radius of curvature at a center of the lenses of the lenticular array.

6. The security element as claimed in claim 3, wherein the lenses of the lenticular array are cylindrical or hemispherical.

7. The security element as claimed in claim 3, wherein the lenticular array is selected from the group consisting of coplanar hemispherical lenses positioned in staggered rows, hexagonal lenses arranged in a honeycomb configuration, and juxtaposed cylindrical lenses.

8. The security element as claimed in claim 2, further comprising the first pattern and the second pattern having a set of unconnected pattern elements, each pattern element being positioned opposite a corresponding lens,
wherein each pattern element of the first pattern is positioned on a first side of the corresponding lens and each pattern element of the second pattern is positioned on a second side of the corresponding lens, the first and the second sides of the corresponding lens being opposite with respect to a center axis thereof.

9. The security element as claimed in claim 2, wherein the reflective, the semi-reflective, or the at least partially opaque surface is metallic.

10. The security element as claimed in claim 2, wherein the first pattern and the second pattern are printed on the reflective, the semi-reflective, or the at least partially opaque surface.

11. The security element as claimed in claim 1, further comprising an adhesive, the adhesive being disposed on the first and the second faces of the substrate.

12. The security element as claimed in claim 1, further comprising an adhesive being disposed on the first face of the substrate, wherein the optical structure is devoid of adhesive.

13. The security element as claimed in claim 12, wherein the substrate is of an elongated shape, the adhesive being disposed on edges thereof.

14. The security element as claimed in claim 1, further comprising unconnected magnetic elements forming a magnetic code.

15. The security element as claimed in claim 14, further comprising the magnetic code having at least two magnetic materials having high and different coercivities, the magnetic materials being arranged to have substantially equal remanences.

16. The security element as claimed in claim 14, further comprising a weakly coercive magnetic zone covered at least partially with a highly coercive magnetic zone, wherein the highly coercive magnetic zone magnetizes the weakly coercive magnetic zone.

17. The security element as claimed in claim 1, wherein the security element is disposed within a security support, the security support being of a material selected from the group consisting of natural fibrous materials, synthetic fibers, and combinations thereof.

18. The security element as claimed in claim 17, wherein the security element is in a form of a thread, the thread being at least partially integrated into the security support.

19. The security element as claimed in claim 17, wherein the security element is in a form of a strip or a patch applied to a surface of the security support.

20. The security element as claimed in claim 1, wherein the security element is integrated into a security document, the security document being selected from the group consisting of a passport, an identity card, a driver's license, an interactive trading card, a playing card, a payment card, a banknote, a gift token, a voucher, a travel pass, a loyalty card, a benefit card, an event ticket, or a combination thereof.

21. A method of authenticating a security document having a security element, the security element comprising a substrate having a first face and a second face, the first face equipped with an optical structure, the second face having at least a first pattern and a second pattern inscribed thereon, the first and the second patterns being at least partially identical, the method comprising:
observing the first pattern at a first position on the second face through the optical structure along a first viewing angle;
observing the second pattern through the optical structure at a second position on the second face along a second viewing angle; and
evaluating the authenticity of the security document by comparing the first and the second observed patterns.
